(19) United States
(12) Patent Application Publication
(10) Pub. No.: US 2013/0221570 A1
(43) Pub. Date: Aug. 29, 2013

(54) METHOD OF MANUFACTURING A COMPOSITE PART BY INJECTING RESIN INTO A TOOL, AND DEVICE COMPRISING THIS TOOL

(71) Applicant: SNECMA, (US)

(72) Inventors: Emilie LESIZZA, Courbevoie (FR); Stephane Andre LEVEQUE, Marcoussis (FR); Dominique MAGNAUDEIX, Yerres (FR)

(73) Assignee: SNECMA, Paris (FR)

(21) Appl. No.: 13/774,024

(22) Filed: Feb. 22, 2013

(30) Foreign Application Priority Data
Feb. 23, 2012 (FR) 12 51651

(51) Int. Cl. B29C 45/14

(52) U.S. Cl. CPC B29C 45/14
USPC 264/279; 425/129.1

(57) ABSTRACT

The resin that will fill a cavity for a part to be moulded and will be polymerised in it, does not reach the cavity until having circulated in a long conduit, formed on the parting line of the tool containing the cavity, so as to take advantage of the thermal inertia of the tool to heat the resin to the required stable temperature, instead of heating it in a less stable manner in the thermally insulated pipes external to the tool. Temperature variations resulting either from heat losses in the pipes external to the tool, or from overheating due to excessively fast polymerisation are thus avoided.

The subject of this invention is a method of manufacturing a composite part in which the resin is injected into a tool comprising a cavity with the same shape as the part so as to obtain a casting, before polymerising the resin, and a device comprising this tool, that can be used with this method of manufacturing the part.

Such a part may be a blade with a composite structure, composed firstly of a fibre preform installed in advance in the tool, that the resin will impregnate when it is injected.

The various temperature constraints must be respected if the part is to be well manufactured. The resin and the preform must thus be at the same temperature, and the viscosity of the resin must facilitate impregnation of the preform and thus assure good quality of the material in the part after polymerisation. It is difficult to respect this condition because the cross-linking reactions that occur during polymerisation are strongly exothermic and therefore chain reactions can occur leading to a sudden unstable situation in which the temperature of the entire injected resin increases suddenly, adversely affecting the quality of the part because the ideal injection temperature is not maintained, or even explosion of the injector and the tool due to an excessive pressure increase.

This risk of overheating is controlled by keeping the resin at a relatively low temperature in the injector and increasing its temperature along the path between the injector and the tool, so that it reaches the required temperature only when it reaches this tool. A defined length of pipe heated to a temperature above the injector temperature is placed between the injector and the tool. This solution has the disadvantages that in practice, the pipe length necessary to heat the resin from the relatively low temperature required at the injector as it travels along its path is excessive, and that stable heating cannot be maintained throughout the injection, such that in the end, the resin is not hot enough when it reaches the tool; it would also be complex to use a special heating device to maintain the temperature of pipes during injection.

The invention was designed to overcome these disadvantages. The idea is to impose a defined path length on the resin inside the tool before the resin reaches the moulding cavity, so that it can reach the required temperature throughout the injection duration, the tool being heated and easily kept at a constant temperature due to its thermal inertia that is much higher than the thermal inertia of the pipes. Therefore, the temperature rise of the resin between the injector and the moulding cavity is mainly or even exclusively applied inside the solid tool containing the cavity. Note that the heating length required to feed at the required temperature is generally much shorter than with external parts, heating being much more efficient under the conditions of the invention.

In a general form, the invention thus relates to a method of manufacturing a composite part formed from a preform and polymerised resin, consisting of installing the preform in a cavity of a tool formed from at least two moulding shells assembled at at least one parting line, injecting the resin into the cavity and then heating it to polymerise it, characterised in that it comprises a step consisting of making the resin pass through a conduit internal to the tool, extending between an orifice external to the tool and the cavity, and some of its length opens up on at least one of the parting lines, either passing through it or being partially delimited by it, and the tool is heated in a regulated manner while the resin is being injected into the cavity.

Since the external pipework is not very useful or even useless for heating the resin and is expensive (it is usually made of copper), it is advantageously shorter or very much shorter than the conduit internal to the tool.

There is usually no point in heating the external pipework between the injector and the tool while the resin is circulating in it.

The invention also relates to a device for manufacturing a composite part that can be used with the method presented above, and comprising a tool formed from at least two moulding shells assembled at at least one parting line and containing a cavity for the part opening up onto one of the parting lines, characterised in that it comprises a resin injection conduit extending between an orifice external to the tool and the cavity and a length of which leads to at least one of the parting lines either extending through it or being partially delimited by it, and heating means. We have seen that the conduit internal to the tool can conveniently heat the resin with good temperature stability. Its main portion usually opens up onto the parting line, so that it can be cleaned after polymerisation when the tool is open. The conduit considered extends from an inlet into the tool to the moulding cavity, and can also extend along the moulding cavity. It may be restricted to this portion opening up on the parting line, from the inlet orifice into the tool as far as the outlet into the moulding cavity, or it may comprise a much shorter connection leading to the inlet orifice into the tool.

The main portion of the conduit may be sinuous in a quadrilateral zone or along a longer side of the cavity, or in the form of a loop, these various arrangements usually leading to favourable constructions of the tool.

However, it is possible that the tool does not have enough space to hold a sufficiently long conduit at the parting line that separates the enclosure. In this case the tool can be constructed with three shells assembled at two parting lines, the cavity opening up onto only one of them, the main portion of the conduit then extending onto the other parting line.

The invention will now be described with reference to the following figures that describe details of its main aspects through several non-exclusive embodiments:

FIG. 1 shows the device in general;

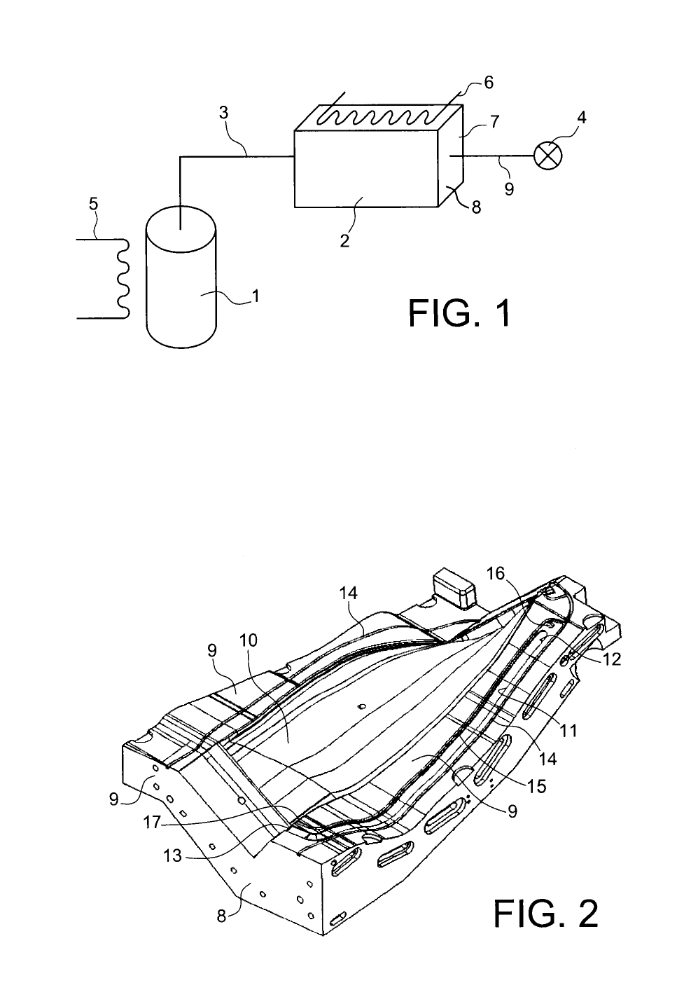

FIGS. 2, 3, 4 and 5 show several embodiments of the device;

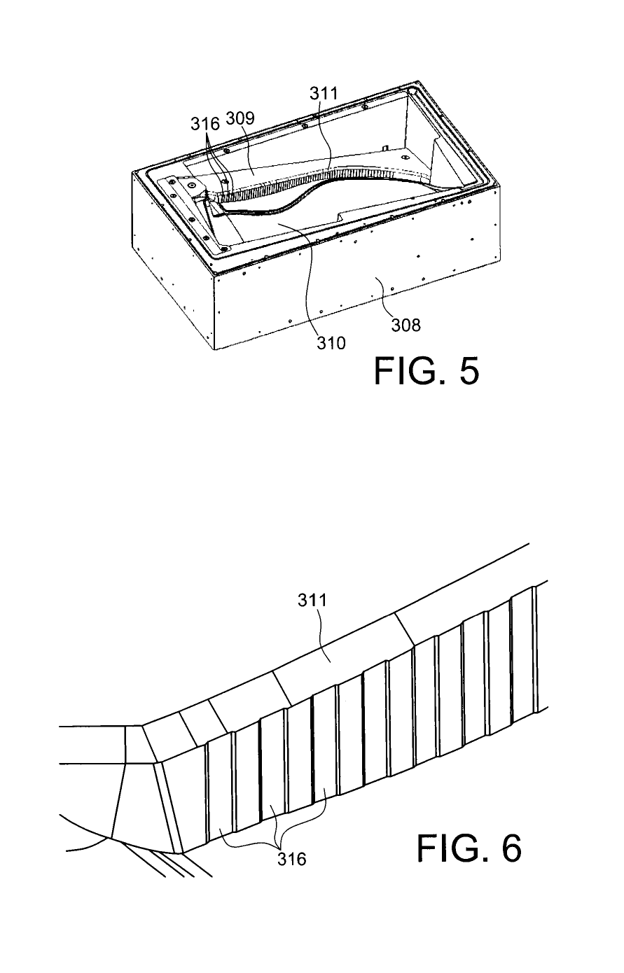

and FIG. 6 is an enlargement of FIG. 5.

FIG. 1 shows a device for making a composite part, comprising a resin injector 1, a tool 2, a cavity 10 of this tool in which the part to be manufactured is moulded, and a pipe 3 connecting the injector to the tool 2, this pipe being dedicated to circulation of resin, and possibly continuing beyond the tool 2 as a far as a vacuum pump 4, which draws in resin from the injector 1 that also pushes the resin. The resin passes through the cavity in the tool 2 and gradually fills it in order to form the part by impregnating a preform of the part to be fabricated that is already there. Heating devices 5 and 6 adjust the temperature of the injector 1 and the temperature of the tool 2 respectively to the required values. The tool 2 is composed of two mounding shells 7 and 8 assembled at a parting line 9. The cavity 10 opens up onto the parting line 9, and the fabricated part may be removed from the mould by separating the shells 7 and 8.

Refer to FIG. 2 that shows one of the shells 8 and the corresponding portion of the cavity 10 at the centre of this shell 8. The shell 8 also comprises a conduit 11 opening onto the parting line 9 and that extends between an orifice 12 leading to the outside of the tool and connected to the pipe 3, towards injector 1, and another orifice 13 opening up into the cavity 10. Another orifice of the shell 8, not shown herein, opens up into the cavity 10 and connects it to the downstream portion of the pipe 3 and to the vacuum pump 4.

Therefore the resin outlet from injector 1 and pipe 3 passes through the conduit 11 from orifice 12 to orifice 13, before filling the cavity 10. In this case the conduit 11 runs along one of the long sides of the cavity 10 and the part to be manufactured, and therefore is long. The resin in it is gradually heated until it reaches the required temperature as it reaches the orifice 13, being heated by the material of the shell 8. The higher thermal inertia of the tool 2 guarantees stable and progressive heating of the resin. Therefore, it must be assumed that it will always be at the required temperature, as it enters the cavity 10, with very small differences. Therefore the risk of an excessive and accidental release of heat leading to an exothermal chain polymerisation reaction is very much reduced.

The shell 8 is provided with grooves in which seals will fit and particularly a groove 14 surrounding the cavity 10 and the conduit 11 and another groove 15 separating the conduit 11 from the cavity 10, extending between a junction 16 at the previous groove 14 and an end 17 opening up into the cavity 10. The seals prevent accidental resin flows either around the cavity 10 or around the conduit 11.

In this embodiment, the conduit 11 opens up onto the parting line 9 over its entire length between the inlet orifice 12 into the tool 2 and the outlet orifice 13 opening up into the cavity 10, so that it can be cleaned after the part has been manufactured, the resin that it contains then being removed. It can be shared between the shells 7 and 8 or it can be formed in only one of them.

The following describes other embodiments of the invention.

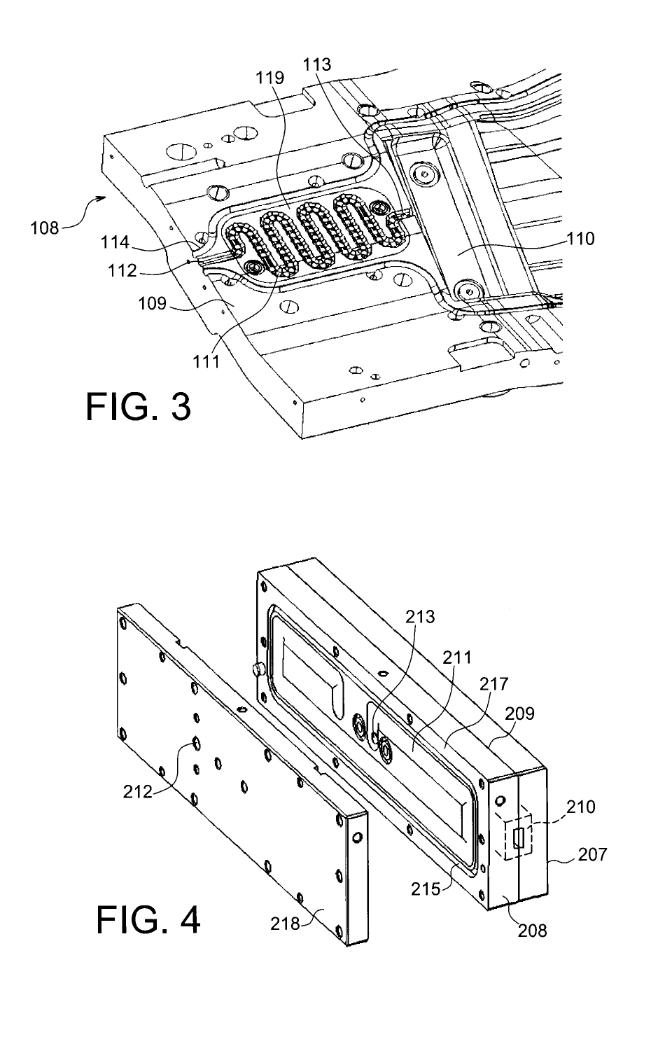

FIG. 3 shows another shell 108 in which there is a sinuous conduit 111 through which the resin passes and which opens up onto its parting line 109 and extends between an orifice 112 leading to the outside and another orifice 113 leading to the cavity 110, and this conduit curves within a quadrilateral zone 119 between the orifices 112 and 113. This arrangement can be useful for maintaining a sufficient length of the conduit 111 if it is impossible to arrange it along the cavity 110.

Operation of the invention is exactly the same as in the previous embodiment. Note that the orifice 112 leading to the outside also opens up onto the parting line 109, which could be the case in the previous embodiment. A groove 114 surrounding the cavity 110 and the conduit 111 also contains a seal preventing resin from flowing into the parting line 109.

FIG. 4 shows a slightly different design, in which the conduit 211 does not extend in the parting line 209 separating the two shells 208 and 207 delimiting the cavity of the part to be moulded, but in another parting line 217 on another face of the shell 208 opposite the parting line 209, and that is an assembly plane of the shell 208 to a third shell 218. The conduit 211 then extends between a first resin supply orifice 212, in this case passing through the third shell 218, but it can also extend in the parting line 211, and an orifice 213 passing through the shell 208 as far as the cavity 210 delimited between the shells 207 and 208. The conduit 211 can curve over the entire surface of the parting line 209 and in particular extend in the form of a loop. It is surrounded by a groove 215 in which a seal is fitted.

FIGS. 5 and 6 show another type of design in which the resin circulation conduit 311 runs along the cavity 310, opening up onto it over a long length instead of opening up onto it through an orifice such as 113 or 213. Resin distribution into the cavity 310 may be controlled through grooves 316 that are parallel to each other, connected to different points of the conduit 311 and opening up onto the cavity 310 extending along its depth direction. This arrangement distributes the resin fairly uniformly along the conduit 311, along the direction of the length of the part to be made and along the direction of its thickness. The resin is also heated a last time in the grooves 316 and it achieves even better temperature uniformity than in the conduits 311.

In general, since the resin supply conduit extending from an inlet orifice into the tool to the moulding cavity is long enough so that the resin can be warmed up (although it is much shorter than the length of the external pipes used for heating in previous designs), it is preferred that the majority of its length or all or almost all of its length, opens up onto the parting line to facilitate cleaning after moulding, particularly because the conduit is usually curved.

Advantageous embodiments thus comprise a conduit extending entirely in the parting line from the inlet orifice into the tool as far as the outlet orifice into the cavity (like the embodiment in FIG. 3), namely a conduit comprising a much shorter connection leading to an inlet orifice through one of the shells (like the embodiment in FIG. 2) in addition to the main portion opening up on the parting line. The embodiment in FIG. 4 also comprises a connection between the main portion and the cavity through one of the shells, but that is much shorter than this main part. The portion of conduit that extends between the cavity and the outlet orifice leading to the vacuum pump 4 may also extend in the parting line of the shells, although this is not necessary because this portion in which there is no longer any need to heat the resin will generally be short, and easier to clean.

1. A method of manufacturing a composite part formed from a solid preform and polymerised resin, comprising installing the solid preform in a cavity of a tool formed from at least two moulding shells assembled at at least one parting line, injecting the resin into the cavity and then heating the resin to polymerise the resin, further comprising a step of making the not yet polymerised resin pass through a conduit internal to the tool, extending between an orifice outside the tool and the cavity, and a length of said conduit opens up on at least one of the parting lines, either extending through the conduit or being partially delimited by the conduit, and heating the tool in a regulated manner while the resin is being injected into the cavity.

2. The method of manufacturing a part according to claim 1, wherein said length extends along a main portion of the conduit.

3. The method of manufacturing a part according to claim 2, wherein the pipework is not heated while the resin is injected into the cavity.

4. A device for manufacturing a composite part, comprising a tool formed from at least two moulding shells assembled at at least one parting line and containing a cavity for the part opening up onto one of the parting lines, further comprising a resin injection conduit extending between an orifice external to the tool and the cavity and a length of said conduit leads to at least one of the parting lines either extending through said conduit or being partially delimited by said conduit, and regulated heating means for the tool.

5. The device for manufacturing a composite part according to claim 4, wherein the main portion of the conduit extends and is sinuous in a quadrilateral zone.

6. The device for manufacturing a composite part according to claim 4, wherein the main portion of the conduit extends along a longer side of the cavity.

7. The device for manufacturing a composite part according to claim 4, wherein the main portion of the conduit extends in the form of a loop.

8. The device for manufacturing a composite part according to claim 4, wherein the tool comprises three shells assembled at two parting lines, the cavity opening up onto one of the parting lines and the main portion of the conduit opening up onto the other parting line.

9. The device for manufacturing a composite part according to claim 4, wherein the main portion along the length of the conduit opens up also onto the cavity.

10. The device for manufacturing a part according to claim 9, wherein the main portion of the conduit comprises distribution grooves that are connected to it and extend along a depth direction of the cavity by opening up onto the cavity.

11. The device for manufacturing a composite part according to claim 4, wherein it comprises a resin injector, a pipe connecting the resin injector to the orifice external to the tool, and regulated heating means for the injector.
